(19) United States
(12) Patent Application Publication
(10) Pub. No.: US 2007/0192798 A1
(43) Pub. Date: Aug. 16, 2007

(54) Digital content delivery via virtual private network (VPN) incorporating secured set-top devices

(76) Inventor: Barrett Morgan, Salt Lake City, UT (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/649,331

(22) Filed: Jan. 3, 2007

Related U.S. Application Data
(60) Provisional application No. 60/755,630, filed on Dec. 30, 2005.

(51) Int. Cl. H04N 5/445; H04N 7/173; G06F 3/00; G06F 13/00

(52) U.S. Cl. 725/51; 725/39; 725/110; 725/112

(57) ABSTRACT

A method and system for delivering digital content to a multitude of set-top devices that are purchased by consumers and connected to the Internet as part of a virtual private network (VPN) provides more efficient and secure distribution of digital content such as movies, television, music, games and other digital media. Each set-top device is secured by using a mass storage device to store digital content that is partitioned into a consumer portion and a VPN portion. Unlike traditional computers that can access digital content on the Internet with browser interfaces running on computer displays, the set-top devices have limited operating system access with no browser interfaces and are designed to be operated by the consumer from a navigation and program guide user interface displayed on a digital media device.

### PRIORITY CLAIM

The present invention claims priority to the U.S. Provisional Patent Application Ser. No. 60/755,630, filed Dec. 30, 2005, and entitled “Digital Content Delivery Via Virtual Private Swarming Network (VPSN) Incorporating Secured Settop Devices”, the disclosure of which is hereby incorporated by reference.

### FIELD OF THE INVENTION

The present invention relates generally to methods and systems for delivery of digital content, such as movies, television, music, games and other digital media, over the Internet. More particularly, the present invention relates to methods and systems for delivery of digital content to a multitude of secured set-top devices (SSDs) having partitioned mass storage with limited operating system access that are purchased or otherwise legally obtained or generated by consumers and incorporated into a virtual private network (VPN).

### BACKGROUND OF THE INVENTION

Delivery of digital media content over the Internet (whether broadband, wireless, fiber or other IP protocol transmission channel and whether Internet v4.0, v6.0 or future embodiments) is anticipated to be the next major revolution in the entertainment industries of movies, television, music and gaming. Unfortunately, significant issues related to digital rights management (DRM) have delayed and, in some cases, derailed progress toward realizing this digital content revolution. Content owners in the entertainment industries have justifiable concerns about the unfettered and illegal copying of digital content that is made available over the Internet. Much of these concerns have focused on the recently developed techniques of peer-to-peer (P2P) file sharing, such as the P2P services provided by eDonkey, FastTrack (Grokster and KaZaa) and Gnutella (Gnucleus, LimeWire, Morpheus, Phex and Shareaza).

P2P file sharing networks work differently than conventional client-server file downloading systems. In a conventional client-server file system a digital content file would be stored on one or more centralized computers (the server) that are authorized by the content owner to make the file available over the Internet. In response to a legitimate request by a user, the digital content file is downloaded or streamed over the Internet from the server to the requesting user's personal computer (PC) (the client). In a P2P file sharing network, various users post digital content files as being available on the network and other users can then access and download those files. Once downloaded, the files are then available from both the original user and the other users who have downloaded the file. In the P2P file sharing network there is no centralized server and any user with a copy of the file on the network can end up being the “server” for downloading that file to the next “client.” In this way, all of the users in the P2P network are peers in that each user can be both a client and a server.

A further improvement of P2P file sharing networks that has gained increasing acceptance is the use of a technique that divides a given digital file into smaller file segments or packets and spreads these packets broadly out over the network to users who have downloaded the digital file. When a request is made for a copy of the file, the swarming technique randomly requests different packets from whichever peer servers in the P2P network have a copy of the packet. The result is a mesh of packets, which, with a large number of users, can be downloaded in parallel for faster downloads to the requester from a multitude of different peer servers over a variety of different Internet paths. The packets are then automatically reassembled by software on the requester into their proper order to recreate the digital content file. This technique of downloading a single file in pieces from multiple sources was originated by Justin Chapweske under the name SwarmCastingυ. Examples of such swarming P2P networks include BitTorrent™ and BearShare™.

P2P networks have a distinct advantage over conventional client-server file downloading systems, as well as traditional satellite, cable and broadcast distribution of digital content files, namely the decreased cost of getting the files downloaded to the end users. By relying on a peer-to-peer network of otherwise unaffiliated PCs, the P2P file sharing network avoids most of the expense of the infrastructure that is otherwise necessary to support high quality and timely streaming download of digital content files. Unlike the expensive transmission equipment needed by traditional satellite, cable and broadcast delivery systems, a P2P network makes use of an existing Internet connection of each of the unaffiliated PCs. Unlike a conventional client-server file downloading system, it is not necessary in a P2P network to maintain a large server farm to meet the anticipated bandwidth demands necessary to support effective streaming of a popular digital content file. The more a file is downloaded in a P2P network, the more “copies” of that digital content file are available to be downloaded in response to increased demand for the file.

Unfortunately, the decentralized and unaffiliated nature of P2P networks which works so well to their advantage in terms of cost and efficiency of downloading digital content files, also presents a decided disadvantage in using P2P networks for downloading digital content files. The decision by the United States Supreme Court in MGM v. Grokster has made it clear that copying of copyrighted material by unauthorized peer-to-peer services is illegal under current United States copyright laws. Because P2P networks are by definition networks of unaffiliated PCs and because the user of each PC has the capability of uploading or modifying any digital file stored on their PC, existing P2P networks have very limited ability to effectively police the source or authorization required for storing and forwarding copyrighted digital content files.

As a result, legal download services for digital content files over the Internet, such as the very successful introduction of the iTunes™ music download service by Apple Computer, have primarily used conventional client-server file downloading systems and either offered the content for free or provided mechanisms that permit users to pay for the copyrighted material prior to downloading the digital content file from the authorized server. Some versions of P2P digital content distribution system, such as the Kontiki Delivery Network, have been adapted to attempt to address these issues either by limiting the content distribution to enterprise specific private intranets or by incorporating Digital Rights Management (DRM) software into the P2P file sharing software. While there have been numerous proposals for resolving the copyright issues through sophisticated DRM systems, such as the Advanced Access Content System (AACS), to date none of these DRM systems have gained wide spread acceptance among either content providers or consumers.

Another approach to utilizing P2P file sharing networks for digital content delivery has been suggested by Alio TV as described in U.S. Patent Publ. Appl. Nos. 2005/0177624A1, 2005/0177853A1 and 2005/0177745A1. In the Alio TV system, a combination of conventional client-server control of downloads in the form of a centralized scheduler and customer management server and a P2P file sharing approach are used to deliver encrypted digital content files to consumers in response to the consumer selecting a desired digital content media (e.g., a movie) from an on-line catalog of available titles. In one embodiment, the encrypted files are downloaded to a consumer set-top box (STB) via a broadband Internet connection. The STB is provided with a browser interface for accessing the on-line catalog and the consumer is permitted to watch the movie once the centralized scheduler has determined that the consumer is authorized to decrypt a given file in response to receiving appropriate payment, for example. Consumer access to the digital content file is controlled by an authorization key received from a customer management server. The on-line catalog solves a problem in prior P2P file sharing networks in which the available content is constantly changing and sometimes difficult to identify. Availability of digital content files is managed by having each consumer create a priority list of digital content files that are preferably made available locally by the system.

While the Alio TV approach offers a solution for some of the problems inherent in utilizing P2P file sharing networks, the requirement for an on-line catalog and distribution of authorization keys for specific digital content files to enable consumer access limits the effectiveness of the P2P sharing network to the network efficiencies associated with downloading entire files. As a result, the Alio TV approach is unable to take advantage of the most recent advances related to swarming techniques for P2P file sharing networks. In addition, while the on-line catalog and encrypted file approach suggested by Alio TV may be well suited for movies and video-on-demand applications, the approach is not well suited for other types of digital media content, such as television programs. The approach suggested by Alio TV has no ability to handle television programs that have been recorded by consumers, instead of being originated by a content provider.

Although conventional client-server file downloading systems offer many advantages over other ways of delivering digital media content to consumers, it would be desirable to provide for methods and systems for delivery of digital media content over the Internet in such a way that could take advantage of the benefits of a P2P file sharing network, and particularly the benefits of swarming techniques for P2P file sharing networks, without incurring the problems inherent in the decentralized and unaffiliated nature of such P2P networks.

### SUMMARY OF THE INVENTION

The present invention is a method and system for delivery of digital content to a multitude of secured set-top devices (SSDs), including secured portable devices (SPDs) and secured auto devices (SADs) that are purchased by consumers and connected to the Internet as part of a virtual private network (VPN). Each SSD is secured by using a mass storage device to store digital content that is partitioned into a consumer portion and a VPN portion. Unlike traditional computers that can access digital content on the Internet with browser interfaces running on computer displays, the SSDs have limited operating system access with no browser interfaces and are designed to be operated by the consumer from a common navigation and program guide user interface displayed on the screen of a digital media device. Digital media files are transferred among the set-top devices in the VPN by peer-to-peer digital content delivery techniques, which in one embodiment referred to as a virtual private swarming network (VPSN) includes packet-based swarming techniques where the digital media files are split into multiple smaller pieces or packets. In one embodiment, the digital media files available for download over the VPSN are stored in a keystoned manner such that selected portions of the file are not stored locally on the set-top device and the set-top devices are provided with encoded hardware that fingerprints each file stored by a given set-top device. By using a VPN incorporating a multitude of SSDs, the present invention provides a more efficient and secure distribution of digital content such as movies, television, music, games and other digital media over the Internet.

The partitioning of the mass storage on the SSD into a local consumer portion and a VPN portion enables consumers to effectively use the SSD to exercise their legal copyrights to make permissible backup copies for archival storage or personal time-shifting purposes. Preferably, the purchase of each SSD includes a click-through End User License Agreement (EULA) that is activated upon connection of the SSD to the Internet. In one embodiment, the consumer or purchaser owns the local consumer portion of the mass storage, but does not own the VPN portion. Instead, the EULA preferably sets the terms and conditions under which the consumer or purchaser is licensed to use the VPN mass storage portion as part of the VPN. In this way, legitimate backup copies can be made available for individual redisplay on a variety of display devices that could be connected in a household local area network (household network). This feature of the present invention also enhances the ability to provide security and control of the copyrighted material of third parties by ensuring that the consumer has different legal rights when accessing the local consumer portion versus the VPN portion of the mass storage.

Preferably, the SSD can also selectively make authorized copies stored on the local consumer portion of the mass storage available over the VPN after confirming that the digital media content files are available on the VPN via, for example, a management and authorization database system. For example, the digital media content files might be licensed for general public usage, or the purveyor of the VPN can negotiate with the copyright holders the right to permit limited copying to occur over the VPN for purposes of supporting the authorized download by individual consumers. Such authorization could also come in the form of an agreement to watch advertisements in the digital media content files where the SSD selectively precludes the consumer from fast forwarding through the advertisements. Authorization could also be made available either on a pay-per-view basis, for a single viewing or a time block of viewing, purchase of the copyrighted material, or even on a subscription basis, such as a monthly subscription that permits an individual consumer to record and/or download certain digital media content, such as over-the-air, cable or satellite television broadcasts without advertising or with only limited advertising between programs.

In one embodiment, the SSD may be selectively programmed only to permit download of digital media content files for television broadcasts, for example, only from a given geographic region relevant to the geographic region in which the SSD is situated such that local advertisements are effectively retained with a given television show. Alternatively, for the pay-per-view or subscription model, the SSD may track viewing of television shows for the purposes of allocating a portion of the revenue from these models between network content providers and local affiliates as a way to offset any potential loss in local advertising income of the network affiliate in the geographic region where the SSD is located. This embodiment could also utilize a presentation of content for swarming distribution where content has a free/no fast forward option/per view pay option/subscription option, splitting up fees based on affiliate/network where affiliate is selected based on zip of SSD, or frontloading ads onto the beginning or end of the no fast forward option. In this manner, the consumer has the ability to choose whether to pay for the digital media content with money or pay with time. The ability to customize ads based on user feedback or profiles may also be integrated into this embodiment.

Advertising is capable of supporting programming if advertisers have some comfort level on the number of eyeballs viewing an advertisement and the embodiment of the present invention in which the consumer are selectively prevented from fast forwarding through the advertising in exchange for receiving free or reduced prices for the digital content can provide advertisers with the desired comfort level. It will be recognized that the dramatically reduced costs of delivering digital media content by the VPSN embodiment of the present invention further enhances the ability to utilize such alternate models for supporting production and delivery of digital media content to consumers.

In one embodiment of the present invention, a plurality of SSDs are purchased and deployed in a motel or hotel, for example, as part of a private network entertainment system. The ability to deploy the SSDs in this manner permits the hotel operator to offer customized sports and television programming, in addition to recent release movies, in accordance with guest preferences without the need to incur the costs of obtaining the desired content in advance of being requested by the guest. In this embodiment a VPSN configuration of SSDs in guest rooms within a hotel enables these SSDs to connect to each other and share movies and other digital media content files. The typical model within a hotel is to have a server in the basement to distribute by streaming the content to a television display in each room. The practical requirements of such conventional server-client streaming capability limit the hotel to being able to offer only about 60 movies. In contrast, the number of movies and other digital media content files which can be offered by this embodiment is essentially unlimited. In addition, this embodiment has the ability to customize programming based on user feedback through loyalty programs. A hotel guest can specify sports teams, TV shows, or other types of content files that they are interested in viewing and those shows would be recorded by one or more SSDs in the VPSN and available for download and viewing upon check-in of the room. For example, a person could specify that they like the University of Utah football and any Utah football games that are available on the VPSN, either within the hotel or, alternatively, on a VPSN external to the hotel system, would be recorded and made available to that guest in any hotel room in America and any hotel in the world equipped with SSDs in accordance with this embodiment. A pay model that includes the no fast forward option could be implemented in this embodiment. In one version of this embodiment, the hotel operator, for example, may negotiate the equivalent of site licenses with various content providers so as to eliminate or reduce the need for partitioning of the HDD of each SSD by permitting site or system wide “backup” of the desired programs or events, instead of limiting the use of the personal backup and time shifting exceptions under copyright laws to specific devices in a given household network.

In another embodiment of the present invention, the retail distribution of SSDs, including SPDs and SADs, is enhanced by a revenue sharing model in which the VPN tracks purchased digital media content files and provides the retailer who sold a given customer the SSD with a prorated portion of the revenue associated with the purchased or rented digital media content files. This revenue sharing model provides a mechanism for the retailer to subsidize a portion of the cost of the SSD from expected downstream revenues generated by purchased download of digital media content files. Preferably, a management and authorization database and software provides accurate tracking of such downloads for a given serial number of the SSD which may be tracked as having been purchased from a particular retailer for purposes of distributing the prorated downstream download revenue. With the growing acceptance of downloaded digital media content, retailers eventually will need some opportunity to participate in this downloading of digital media and content. The VPSN embodiment of the present invention that includes a swarming file transfer method can involve a revenue sharing with the retailer that is an economic model that retailers can deploy without requiring the retailer to incur the cost and expense of traditional server to client download support.

In one embodiment, the SSD is initialized such that the SSD is linked into a credit card account provided by the consumer for authorized purchase of digital content files. Each SSD is provided with a unique serial number, for example, that permits all transactions initiated by the SSD to be fingerprinted and identified as originating from that given SSD. Additional boxes in the household network are married to a given parent SSD. If a box would be removed from a household network and brought into another household network, an initialization question would be asked of the consumer/user as to whether to erase all content on the given box before joining the new household network. In this way, a digital content file stored on other boxes in the household network of a given SSD can be secured. In one embodiment, the activity of the married network participants of a given household network for a SSD may be reported out and tracked over the VPN for central reporting. In another embodiment, heuristic algorithms may be constructed to manage the VPSN portion of HDD in a swarming network. In still another embodiment, VPN servers and management and authorization databases are adapted to accommodate the use of gift cards sold by retail establishments as a payment mechanism for downloading digital content files in addition to credit card authorization.

An alternate embodiment of the present invention utilizes the VPSN to effectively enable a networked backup of local user data on the local consumer portion of the mass storage of the SSD. Preferably, the local user data would be automatically encrypted and swarmed to the VPSN portion of other SSDs in the VSPN. In other embodiments, the local user data would be sent via P2P file sharing techniques where the local user data is sent as a single complete file to one or more other SSDs in the VPN. In one embodiment, this backup feature can be made available to the consumer for a monthly service fee, for example. In another embodiment, the backup feature could remove those files for which the consumer is not the copyright holder from the backup service. Instead, if the consumer is an authorized copyholder for copyrighted material of a third party, that copyrighted material can be selectively reconstructed from digital files stored on other SSDs in the VPN, or from VPN servers as part of a recovery or restore process in the event that the HDD of a given SSD crashes. In this way, the SSD can serve as a household network backup and store for a variety of digital media content files of the consumer, whether those files are originated as CDs, DVDs or computer files on a PC. In one embodiment, a record of all purchases and personal video recorded (PVR'ed) content would be kept in a database by the VPN servers and upon HDD failure a new box would be reintroduced into the household and all of the content could be put back onto the HDD of the new box.

In another embodiment utilizing swarming techniques, the VPSN embodiment of the present invention provides additional security for digital media content files by keystoning files over more than one SSD. Unlike current BitTorrent systems which store an entire file on the hard drive of a user's PC, this embodiment of the present invention keystones certain bits of data off the HDD of a consumer's SSD so that anyone attempting to hack into the HDD on that SSD would only get portions of the digital media content file and not the whole file. For the consumer, however, this security is effectively invisible because the keystoned portions of a given file would be restored on-the-fly, for example, by streaming the keystoned bits of the file from other SSDs or the VPSN server on the VPSN when the digital media file is being played back. This method of Swarmcryption allows content providers to be assured that their digital files are more protected against being compromised because the entire file will never exist in one place at one time if so desired. This embodiment is enhanced by having a minimum bandwidth guarantee for all SSDs in the VPSN that are participating in this method of distribution with Swarmcryption.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a diagram illustrating an overall schematic of a virtual private network (VPN) in accordance with one embodiment of the present invention;

FIG. 2 is a detailed block diagram of one embodiment of an exemplary embodiment of a secured set-top device (SSD) in accordance with one embodiment of the present invention;

FIG. 3 is a graphic representation of an exemplary navigation and program guide user interface used to control an SSD in accordance with one embodiment of the present invention;

FIG. 4 is a diagram illustrating a schematic representation of one embodiment of the VPN management system in accordance with one embodiment of the present invention;

FIG. 5 is a block diagram illustrating the various components and attributes of the SSD and VPN in one embodiment of the present invention; and

FIG. 6 is a diagram illustrating an overall schematic of a virtual private network (VPN) optimized for the downloading and exchanging of consumer-generated digital media files.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

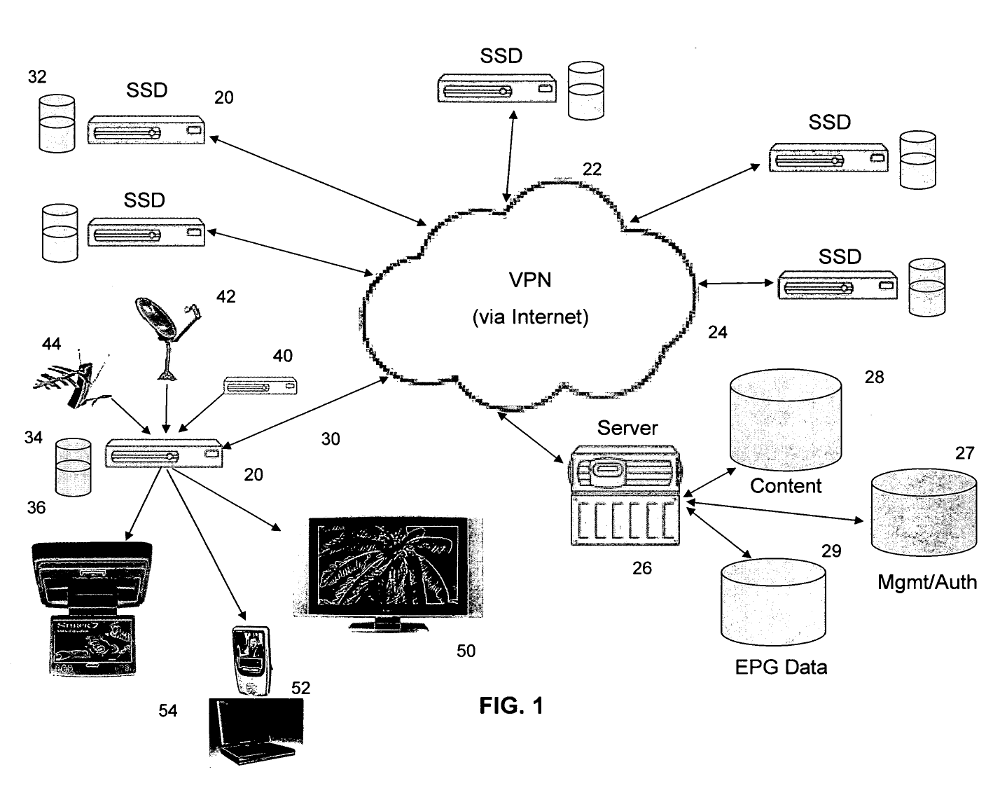

FIG. 1 shows a multitude of secure set-top devices (SSDs) 20 incorporated into a virtual private network (VPN) 22 operating over the Internet 24 in accordance with one embodiment of the present invention. In addition to the SSDs 20, the VPN 22 preferably includes one or more VPN servers 26 that have access to authorized copies of digital media content files 28, such as movies, television shows, music, games, programs and other digital media. As will be described, VPN servers 26 may also have access to management and authorization databases 27 and electronic program guide (EPG) databases 29. New digital content media from third party content providers to be introduced into the network can initially be uploaded and served from the VPN servers 26 until such time as a sufficient number of authorized copies of the digital media content files 28 are stored on the multitude of SSDs 20 in the VPN 22 to enable requests for such files to be serviced using P2P file-sharing techniques, without resorting to the VPN servers 26. While many of the digital media content files 28 will be copyrighted materials generated by third party copyright holders, it will be understood that at least a portion of the digital media content files stored on the SSD 20 can include home video files, personally composed music files, digital photographs taken by the consumer, software programs written by the consumer or data files generated by the consumer, for which the consumer will be the copyright owner.

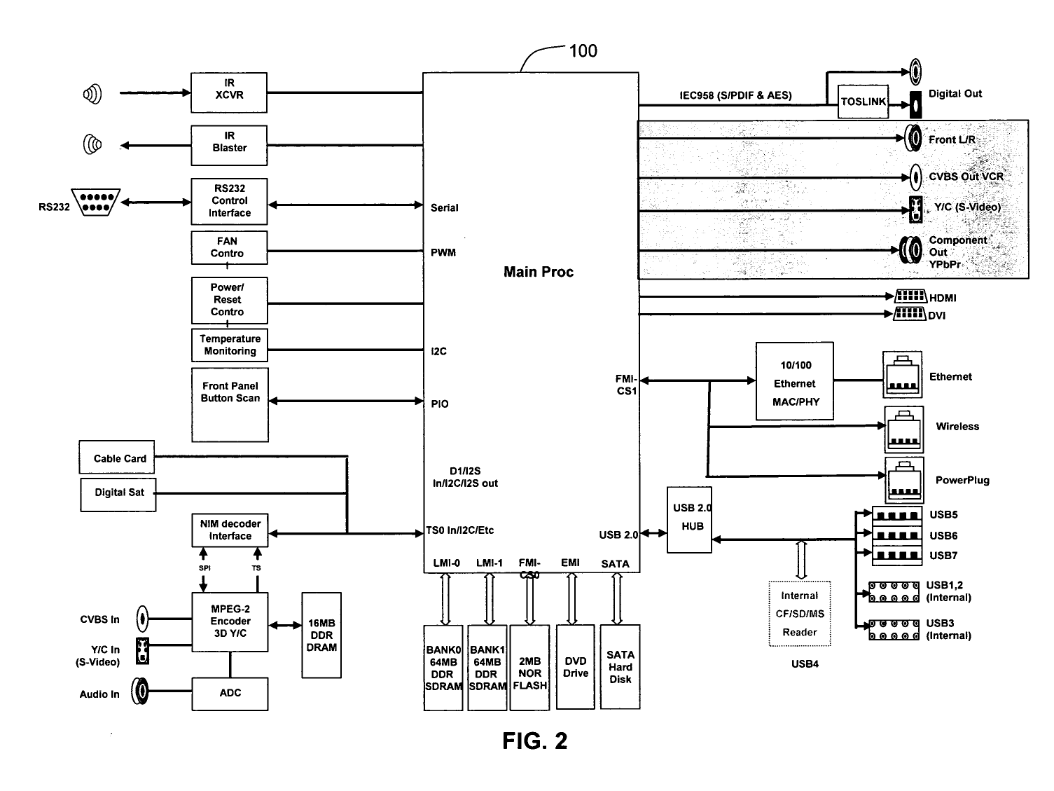

As will be discussed in more detail in connection with the description of FIG. 2, each SSD 20 includes a broadband bidirectional connection 30 to the Internet and a mass storage 32 that selectively stores the digital media content files, such as a hard disk drive (HDD) that is preferably partitioned into a local mass storage 34 and a VPN mass storage 36. For purposes of the present invention, the term SSD will be used to apply to various configurations of digital content storage devices equipped in accordance with one or more of the various embodiments of the present invention, including secured portable devices (SPDs) and secured auto devices (SADs). It will be understood that other types of mass storage devices, such as flash memory, bubble memory, optical read/write memory and the like may also be utilized for the mass storage 32. In one embodiment, the HDD of each SDD is, for example, a 200 GB hard drive in which 150 GB are made available for the local consumer partition 34 and 50 GB are made available for the VPN partition 36. It will be understood that the relative size of the mass storage 32 of each SDD will be primarily a function of economics and currently available mass storage technologies, and that the relative proportions of the local consumer partition 34 and the VPN partition 36 can vary, either by selectable consumer setting or under system control via the VPN servers 26, and that the proportions can change over time either in response to dynamic priority management of the contents of the mass storage or by heuristic algorithms and techniques that optimize either or both of the performance of the individual SSD 20 and the VPN 22. The partitioning of the HDD in one embodiment is accomplished by the creation of different logical drives on a single hard disk drive, although it will be apparent to a person skilled in the art that multiple physical devices or other known techniques for file system and storage management could be used to create the partitioned mass storage 32 in accordance with this embodiment of the present invention.

Each SSD preferably includes at least one additional input connection to content sources such as cable television 40, satellite television 42 and over-the-air television 44, as well as media players such as CD players, DVD players or the like. Each SSD also preferably includes output connections to a variety of display-based digital media devices such as television sets 50, portable video players 52, and automobile media players 54, as well as audio-based digital media devices such as portable media players and stereo systems. In one embodiment, SSD 20 acts as a local hub for a household network by connecting to a multitude of local digital media devices. While the SSD 20 is shown as being a physically separate box, it will be understood that the SSD 20 may be integrated into the enclosure of a TV display, portable media player or integrated into a vehicle.

In one embodiment, each SSD 20 is purchased by a retail consumer at a retail outlet or over the Internet. In another embodiment, one or more SSDs 20 are supplied by a digital media content provider, such as a cable television service provider, in exchange for a consumer paying a periodic fee for access to the digital media content or use of the SSD. In another embodiment, a group of SSDs 20 may be purchased and deployed at a commercial establishment, such as a hotel or motel. Preferably, the purchase of each SSD includes a click-through End User License Agreement (EULA) that is activated upon connection of the SSD 20 to the Internet 24. In a preferred embodiment, the consumer or purchaser owns the SSD 20 including the local mass storage 32, but does not own the VPN mass storage 36. The EULA preferably sets the terms and conditions under which the consumer or purchaser is licensed to use the VPN mass storage 36 as part of the VPN 22.

For a general description and background of digital content delivery by peer-to-peer (P2P) networks and set-top boxes for storing such digital content, reference is made to U.S. Patent Publ. Appl. Nos. 2005/0177624A1, 2005/0177853A1 and 2005/0177745A1, the disclosures of which are hereby incorporated by reference. Unlike the set-top boxes (STBs) that are described in these references, the SSDs 20 of the present invention are not provided with a browser interface or other easily accessible interfaces to the operating system program executing on the main processor 100 of the SSD 20. Instead, each SSD is preferably provided with a navigation and program guide (NPG) user interface 300 in which the operating system is not exposed to the user. The NPG user interface 300 preferably may be accessed through any of the display devices 50, 52 or 54. In one embodiment, a menu-driven electronic program guide (EPG) supported by a server 26, management/authorization database 27, digital media content files 28, and EPG database 29 may be used to populate NPG user interface 300 with information about available digital media content 28 and authorized copies of digital media content files 28.

Although virtually any P2P file-sharing techniques may be used to transfer files between SSDs connected to the VPN, at least one embodiment of the present invention uses swarming techniques. Unlike the disclosure of the P2P network described in U.S. Patent Publ. Appl. Nos. 2005/0177624A1, 2005/0177853A1 and 2005/0177745A1, in this VPSN embodiment, the digital media content files 28 are transferred among the SSDs by a packet-based, peer-to-peer swarming protocol, such as the SwarmCast™ technique available from Onion Networks and described, for example, in U.S. Patent Applications Nos. 10/033,305 and 10/788,695, the disclosure of each of which is hereby incorporated by reference. Alternatively, other equivalent packet-based, peer-to-peer swarming protocols such as BitTorrent™ or BearShare™ may be utilized as the programming techniques for establishing the VPN 22 among the multitude of SSDs 20 in accordance with this embodiment the present invention. In a preferred embodiment of SwarmCast as utilized by one embodiment of the present invention, a request over the VPN 22 for a given digital media content file 26 provides for preferential loading of, for example, beginning of movie, or segments of movie after the point at which the user is watching the movie.

The security afforded by the SSDs 20 of the present invention to protecting against the unauthorized copying of digital media content files 28 is provided in several ways. It will be understood that the principal objective of these measures to secure against unauthorized copying of digital media content files is not to guarantee absolute security, but rather to make any attempted unauthorized access or copying of the digital media content files sufficiently difficult, expensive and tedious that the vast majority of consumers will find it easier and more convenient to resort to purchase of digital media content or other types of authorized use of digital media content, such as agreeing to view digital media content files incorporating advertising into the digital media content files without an ability to fast forward through such advertisements. Security for purchased digital media content files 28 can be enhanced by various known encryption techniques and digital rights management (DRM) techniques. In one embodiment, the digital media content files are stored in any of various digital media file formats, such as Windows Media 9.0 or H264, which require certificates to enable playback. Alternatively, other secure digital media formats such as for RealPlayer™ or QuickTime may be used. In one embodiment, a DRM technique such as available from OpenCASE™ is utilized to manage and authorize copyrighted material from third party content providers. Alternatively, other DRM systems, such as Windows Media® DRM, Real Helix™ DRM, Open Mobile Alliance, or Widevine™ may be utilized.

In one embodiment, security is enhanced by a keystoning technique over the VPN in which an entire digital media content file 28 never resides completely on an individual HDD of a given SSD 20. Instead, selected keystoned segments or packets of the file 28 are stored on other SSDs 20 in the VPN 22 and are temporarily downloaded in response to a request from the consumer to view the particular digital media content file 28.

In another embodiment as shown in FIG. 2, the SSD 20 is provided with selectively controlled analog outputs to discourage unauthorized distribution of analog versions generated from high quality digital media content files 28. The processor 100 in the SSD may be programmed to recognize the source and authorization for particular digital media content files and selectively inform the customer via the NPG user interface 300 that a given digital content file is not available for display over an analog output and that the user should connect the SSD to an appropriate digital display device via the HDMI or VDI output, for example, for which a DRM system can be relied upon to effectively control distribution and display of the given file 28.

An alternate embodiment of the present invention utilizes the VPSN 22 to effectively enable a networked backup of local user data on the local portion 34 of the HDD 32 of the SSD 20. Preferably, the local user data would be automatically encrypted and swarmed to the VPSN portion 36 of at least one other SSD 20 in the VPN 22. If the P2P file transfer protocol used to transfer the local user data is a swarming protocol, then portions of the local user data may be sent to multiple SSDs. In one embodiment, this backup feature can be made available to the consumer for a monthly service fee, for example. In another embodiment, the backup feature could remove those files for which the consumer is not the copyright holder from the backup service. Instead, if the consumer is an authorized copyholder for copyrighted material of a third party, that copyrighted material can be selectively reconstructed from digital files 26 stored on other SSDs 20 in the VPSN 22 or from the VPSN servers 26 as part of a recovery or restore process in the event that the HDD of the SSD 20 crashes. In this way, the SSD 20 can serve as a local area network (LAN) home or household backup and store for a variety of digital media content files of the consumer, whether those files are originated as CDs, DVDs, or computer files on a PC. Each of those devices may be connected by USB, wireless or power line LAN connections to the SSD for purposes of archiving or central storage and access to the digital media content files 28 by the consumer.

It will be understood that one of the principal advantages of partitioning the mass storage 32 of the SSD 20 into a local portion 34 and a VPN portion 36 is to permit consumers to effectively use the SSD to exercise their legal copyrights to make permissible backup copies for archival storage or personal time-shifting purposes. Such legitimate backup copies can be made available for individual redisplay on a variety of display devices that could be connected in household network, such as televisions 50, portable media players 52 or automobile media players 54. The processor 100 of the SSD 20 can also selectively make authorized copies stored on the local portion 34 of the HDD available over the VPN 22 after confirming that the digital media content files 28 are available on the VPN 22 via, for example, the management and authorization database 27. There are a variety of ways in which digital media content files 28 could be authorized for copying and download via the VPN 22. For example, the digital media content files 28 might be licensed for general public usage, or the purveyor of the VPN 22 could negotiate with the copyright holders the right to permit limited copying to occur over the VPN 22 for purposes of supporting the authorized download by individual consumers. Such authorization could come in the form of an agreement to watch advertisements in the digital media content files where the SSD 20 selectively precludes the consumer from fast forwarding through the advertisements. Authorization could also be made available either on a pay-per-view basis, for a single viewing or a time block of viewing, purchase of the copyrighted material, or even on a subscription basis, such as a monthly subscription that permits an individual consumer to record and/or download certain digital media content, such as over-the-air, cable or satellite television broadcasts without advertising or with only limited advertising between programs.

In one embodiment, the SSD 20 could selectively be programmed only to permit download of digital media content files for television broadcasts, for example, only from a given geographic region relevant to the geographic region in which the SSD 20 is situated such that local advertisements are effectively retained with a given television show. Alternatively, for the pay-per-view or subscription model, the SSD 20 could track viewing of television shows for the purposes of allocating a portion of the revenue from these models between network content providers and local affiliates as a way to offset any potential loss in local advertising income of the network affiliate in the geographic region where the SSD 20 is located. This embodiment could also utilize a trifurcated presentation of content for distribution where content has a free/no fast forward option/per view pay option/subscription option, splitting up fees based on affiliate/network where affiliate is selected based on zip of SSD 20, or frontloading ads onto the beginning or end of the no fast forward option.

Referring now to FIG. 2, a more detailed description of one embodiment of an SSD 20 will be presented. In this embodiment, a main processor 100 is the computer processor arrangement responsible for managing operation of the SSD 20. In one embodiment, the main processor 100 is an ST7100 chip, although one or more processor chips or chips with multiple processing cores from various chip manufacturers such as Broadcom® or Intel® could be utilized to implement the processor 100 in accordance with the present invention. In one embodiment of the present invention, the processor 100 utilizes a Linux based operating system together with several application programs to implement the various functions required for the SSD 20.

The main processor 100 can include ports for IR communications with a remote control for controlling the NPG. In one embodiment, the remote control (not shown) can have a limited number of buttons for simplifying user interaction with the NPG. Alternatively, an RS232 interface can be provided to enable customized remote control operation by home automation remote control devices such as are available from Creston®, for example. Ports for monitoring various status and input conditions, such as fan control, power control, temperature and front panel buttons can also be provided.

Unlike other set-top boxes, the SSD 20 of the present invention is preferably provided with multiple content input source connections. In one embodiment, these may include a cable card and digital satellite connection, which provide direct digital input feeds to the DSS, as well as analog inputs that have been digitized by an MPEG 2 encoder, for example.

Preferably, the processor 100 is provided with sufficient RAM memory to implement appropriate caching functions as well as program execution. Nonvolatile memory is provided in the form of a flash memory. In one embodiment, a DVD drive is integrated into the SSD 20 and connected to the processor 100. Alternatively, other digital media input/output devices such as a CD player, or a HD DVD or Blu-Ray DVD player could be integrated into the SSD 20. In one embodiment, the SSD 20 is provided with the capability of ripping recorded digital media files into digital media content from such digital media players. In another embodiment, the digital media players may be permitted to create CSS encrypted files on optical media, for example.

In one embodiment, the SSD 20 is provided with a plurality of USB 2.0 connection ports via a USB 2.0 hub. Certain of the USB ports are used for internal purposes, such as for internal CF/SD/MS readers. Other USB ports are available for external connection for connecting the SSD 20 to other external devices, such as to supplement external HDD or to a personal computer. It should be noted that any access to the SSD 20 via the USB ports is closely monitored and controlled by the operating system executing on the SSD 20 to prevent unauthorized access or control of the SSD via the USB ports.

Internet broadband access is preferably provided via a built-in Ethernet connection. Alternatively, broadband Internet access can be provided through a wireless connection, such as WiFi or WiMAX, or through a power line connection, such as HomePlug®2.0.

Preferably, SSD 20 is provided with digital output connectors in the form of HDDI and DVI connectors or similar digital output connections. In one embodiment, analog output connections may also be provided, but as previously described, the processor 100 may be programmed to monitor and permit only authorized output of digital media content over such analog output connections. In one embodiment, a fiber optic digital audio output is provided.

In another embodiment, the SSD 20 may be linked by USB or a local area network (LAN) connection, either wired or wireless, to other local/home boxes that may include mobile displays or players, i.e., car or portable to form a LAN/household network. In these embodiments, the HDD may be wireless or USB linked or the HDD may be ejectable. Control of local transfer of digital media content files 26 to other HDDs in the LAN/household network can be controlled and managed by the processor 100 in the DSS 20.

In one embodiment, limited and controlled PC access to the digital content files could be permitted through an external port on the SSD 100 via FireWire, wireless, Ethernet or PowerPlug. It will be understood that, unlike conventional PC access between devices, the HDD 32 would be effectively invisible to any remotely connected PC as all access to and from the HDD 32 would be controlled and managed by the processor 100 to protect against unauthorized access of the digital content files using the PC.

In one embodiment, the SSD 20 is initialized such that the SSD 20 is linked into a credit card account provided by the consumer for authorized purchase of digital content files. Each SSD 20 is provided with a unique serial number in the processor 100, for example, that permits all transactions initiated by the SSD to be fingerprinted and identified as originating from that given SSD 20. Additional boxes in the LAN/household network are married to a given parent SSD 20. If a box would be removed from a LAN/household network and brought into another LAN/household network, an initialization question would be asked of the consumer/user as to whether to erase all content on the given box before joining the new LAN/household network. In this way, digital content files stored on other boxes in the LAN/household network of a given SSD 20 can be secured.

In one embodiment, the activity of the married network participants of a given LAN/household network for a SSD 20 may be reported out and tracked over the VPN 22 for central reporting. In another embodiment, heuristic algorithms may be constructed to manage the VPN portion of HDD in a P2P network that may utilize swarming or other P2P protocols.

In one embodiment, the SSD 20 is preferably provided with circuitry, components, software and firmware capable of supporting the following features which are listed by way of example and are not necessarily intended to be limitations and/or requirements:

Watch and record including time shift from 2 digital tuners:
MPEG2 MP@HL
H264 HP
Windows Media Player 9 ΔP
5.1 Dolby (AC3)/WMA/SRS/AAC/AAC+/DD+

HD display connectivity
YPrPb analogue signals
DVI/HDMI digital interface (HDCP support)

HD up scaling including
For digital SD
For any external analogue SD source
For SD DVD playback

SD VCR output

DVD or Analog plane in PIP vs digital plane (and vice versa) DVD+/−RW

DVD player
DVD, SVCD, movies
DIVX from CD and HDD
Audio CD, Dolby Digital (AC3), DTS.
MP3 from CD and HDD (Jukebox)
JPEG
SD recording, compatible with DVD players
Support for software upgrade through CD or through VPSN network
SW ready for all DVD interactive menus
CSS/CPPM/CPRM decryption
CPRM encryption

Preferably, the Hard Disk Drive 32 is provided with
Internal over SATA, or
Connection on USB2.0 port
No Constraint on Product Cost
No constraints on HDD mechanical integration, will improve product reliability
End customer choice for HDD capacity, easy upgradeability
Improved file system for HDD management
SD and HD recording
   Single HD recording doing trick modes (rewind, forward, fast, slow)
   Multiple SD recording
   Archiving from HDD to DVD
   Non real time HDD compression: MPEG2 to H264 transcoding
JPEG album
   from USB2.0 interface for digital camera/memory card connection
   JPEG coprocessor: >6M pixels/s including color conversion and resize

Analog SD inputs
3 external sources (CVBS, Audio Left, Audio Right)
   One connection in front of media server for camcorder connection
   Two connections on rear panel for other equipment
      Operators Set-Top Boxes—Satellite or Cable
      VCR
      DVD players

Analog SD video outputs
NTSC channel modulator for local VCR connection
NTSC agile modulator for home network distribution, in case no wireless solution
YC, CVBS signal

Audio Outputs
Optical or coaxial SPDIF
One set of RCA connectors for Audio Left and Audio Right

Analog SD signal router, SD to SD

Source Signals
3 external sources (CVBS, Audio Left, Audio Right)
HD signal decoded and down scaled to SD format
Media Players attached to HD server
Distribution to second room through RF Agile modulator

SD MPEG2 encoder
NTSC channel_modulator for local VCR connection
NTSC agile modulator for home network distribution,
Upgradeable to Wireless Solution
YC, CVBS signals

Audio Outputs
Optical or coaxial SPDIF
One set of RCA connectors for Audio Left and Audio Right

Ethernet
10T/100T interface
RJ45 connector accessible on rear panel
Target is to connect external ADSL modem
Prepared for next generation wireless interface

USB 2.0
USB2.0 master connector on rear panel of product
External HDD connection for PVR purpose
USB MP3 peripherals applications for music distribution
USB digital camera connection for DVD album recording
Media card support

1394
DV camcorder connection
DV to mpeg transcoding

Advanced Security
Toolbox to support any DRM
Private and public Key programming
Secret on Chip

Video over IP potential application for direct advertising or movies renting

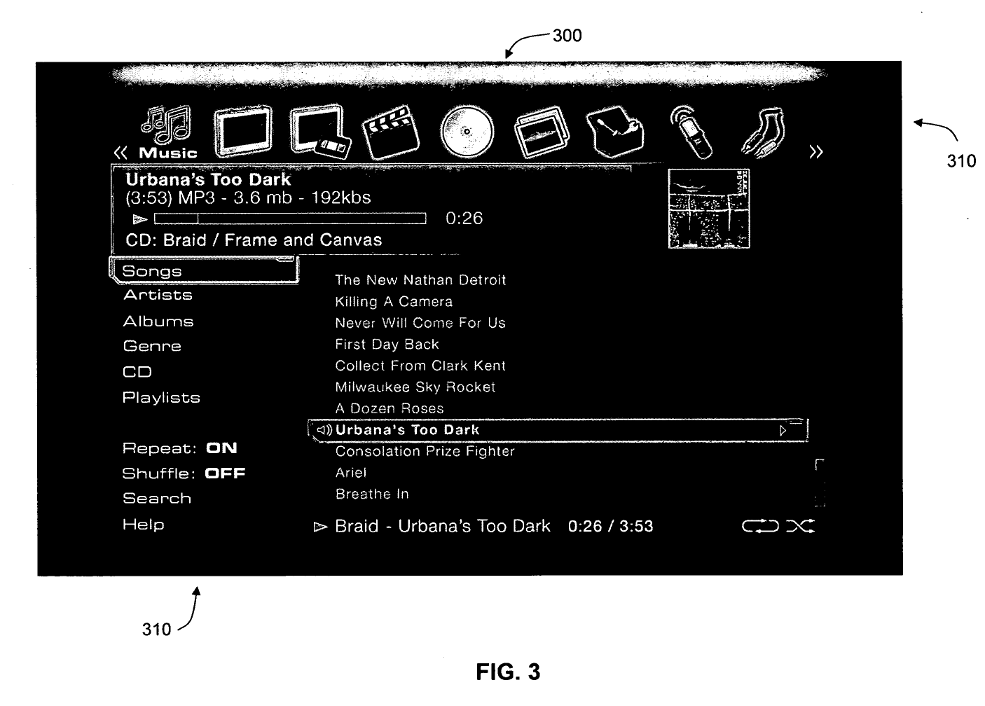

Referring now to FIG. 3, an exemplary NPG user interface 300 is shown. Preferably, the NPG user interface 300 provides a common interface to all digital media content files 28. In one embodiment, persistent icons 310 for different types of media files are presented at an edge of the NPG user interface 300, with a navigation column 320 present along one side of NPG user interface 320 surrounding a main time/channel matrixed menu area. In a preferred embodiment, portions of the NPG user interface 300 are updated and populated over VPN 22 from an electronic program guide database or server 29, such as available from Tribune Media or TV Guide®, for example. Examples of EPG interfaces are shown and described in U.S. Publ. Patent Appl No. 2004/0068742 A1 and U.S. Pat. Nos. 5,585,838, 5,594,509, 5,619,249 and 6,832,386, the disclosures of which are hereby incorporated by reference. In one embodiment, other information such as times and locations of movies playing in a local region may also be displayed on the EPG-supported NPG user interface 300.

In a preferred embodiment, the channel guide data would include IPTV integrated into TV Guide®. PPV Sports, All MLB, NFL, NBA, NHL, as well as a guide to navigate some, or even all, digital media sources. Preferably, this includes TV Program Listings and Movie Meta-Data Services, as well as Data Delivery and Device Management Services.

Preferably, the SSD 20 operates as a digital entertainment center (DEC) or digital video recorder (DVR) fully integrated with IPG for a common user experience. The SSD 20 provides for feature rich DVR with robust conflict management and integrated with tune-in advertising. In one embodiment, NPG user interface 300 for the SSD 20 can be provided with advanced filtering and searching across broadcast TV and recorded programming. The SSD 20 is preferably optimized for both HDTV and SDTV digital media content files.

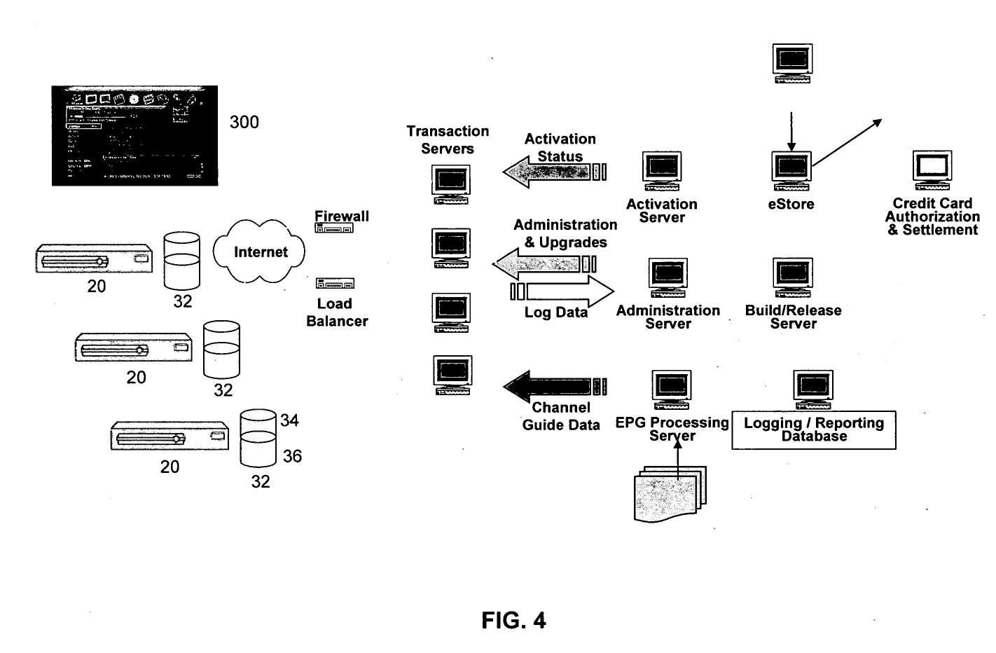

Referring now to FIG. 4, a system for managing set-top box metadata in VPN environment is shown. The Digital Video Recorder (DVR) Application supported by the SSD 20 and VPN 22 provides for digital content data transport and device management services utilizing the management/authorization database 27. These may include data transport and device management services delivered via the VPN 22 by broadband or DSL over the Internet 24 in a manner that provides for robust data delivery infrastructure. Infrastructure can support content and software download, transactions, device logging. Subscription and billing management are also preferably provided.

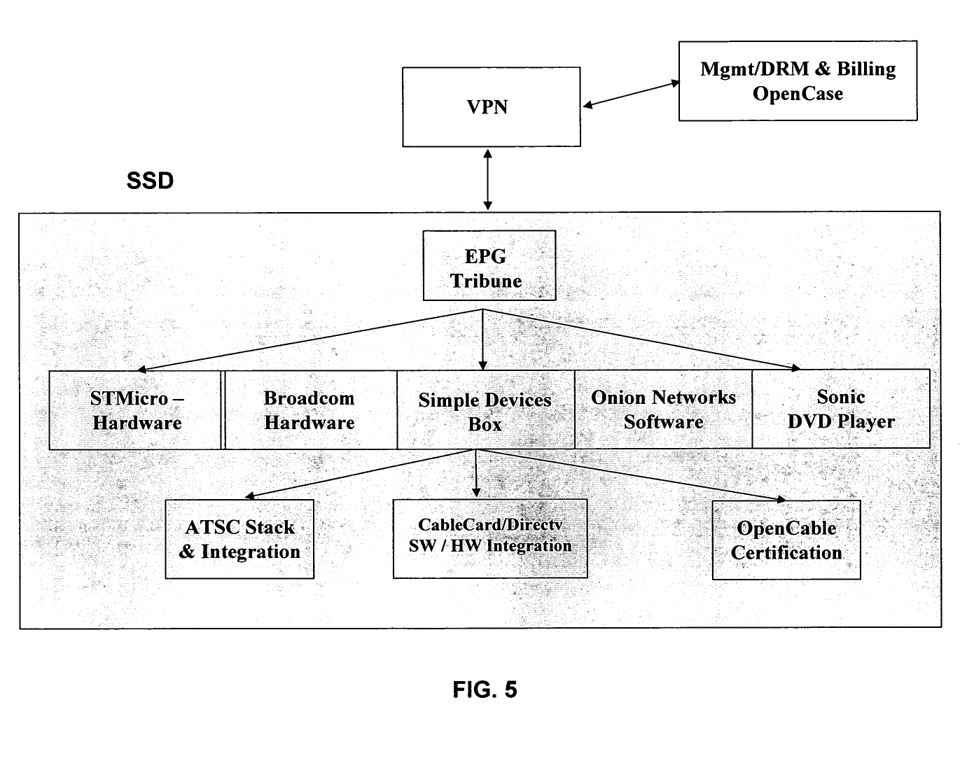

Referring now to FIG. 5, one embodiment of how the various aspects and components of a preferred embodiment of the present invention are implemented will be described. In this embodiment, the VPN 22 is formed of a multitude of SSDs 20 together with the VPN servers 26. Preferably, the multitude of SSDs 20 will number in the thousands or greater for the VPSN embodiment of the present invention. It will be recognized that the efficiency and capacity of the VPSN 22 increases with an increasing number of SSDs 20. Management, authorization, DRM and billing can be implemented by software provided by OpenCASE™, for example. The hardware for the processor 100 can be provided by STMicro with Internet connection chip sets provided by Broadcom®, for example. The implementation of the circuitry and hardware assembly of the SSD 20 can include the ATSC stack and integration for enabling access to over-the-air content, as well as the CableCARD and DirecTV® software and hardware integration to provide access to cable and satellite content, as well as an OpenCable™ certification for the cable content. As previously described, the SwarmCast software that enables the VPSN swarming network 22 is provided by Onion Networks. The DVD player and associated software is provided by Sonic.

In one embodiment of the present invention, a plurality of SSDs 20 are purchased and deployed in a motel or hotel, for example, as part of a private network entertainment system. The SSDs 20 may be connected to a generic VPSN 22, or the SSDs 20 may be connected to a VPSN 22 that is hosted exclusively for the motel or hotel chain, for example. In one embodiment, the ability to deploy the SSDs 20 in this manner permits the hotel operator to offer customized sports and television programming, in addition to recent release movies, in accordance with guest preferences, but without the need to incur the costs of obtaining the desired content in advance of being requested by the guest. For example, if a guest wishes to view a particular sporting event, the SSD 20 can negotiate to obtain a copy of this content from the VPSN 22 in response to the guest request, with the requested content being transferred via a P2P file-sharing technique, including a swarming technique, to the SSD 20 located in the guest's room in a matter of minutes, instead of the overnight download that would typically be required for special ordering of digital media content.

In another embodiment of the present invention, the retail distribution of SSDs 20 is enhanced by a revenue sharing model in which the VPN tracks purchased digital media content files 26 and provides the retailer who sold a given customer the SSD 20 with a prorated portion of the revenue associated with the purchased or rented digital media content files 28. For example, the retailer may be paid a certain percentage of revenue from recently released new content downloaded onto the SSD 20 via the VPSN 22 for a period of time after sale of the SSD 20 as a way to offset the anticipated reduction in the sale of digital media copies, such as CDs or DVDs by the retailer. The revenue sharing model provides a mechanism for the retailer to subsidize a portion of the cost of the SSD 20 from expected downstream revenues generated by purchased download of digital media content files 28. The management and authorization database 29 of the VPN servers 26 permits accurate tracking of such downloads for a given serial number of the SSD 20 which may be tracked as having been purchased from a particular retailer for purposes of distributing the prorated downstream download revenue.

In another embodiment, the VPSN servers 26 and management and authorization database are adapted to accommodate the use of gift cards sold by retail establishments as a payment mechanism for downloading digital content files 26 in addition to the credit card authorization as previously discussed. In one version of this embodiment, the SSD 20 is provided with a bar code reader or mag stripe card reader to permit the consumer to easily enter the gift cards for redeeming the gift card amounts as payment for the download of digital content files 28.

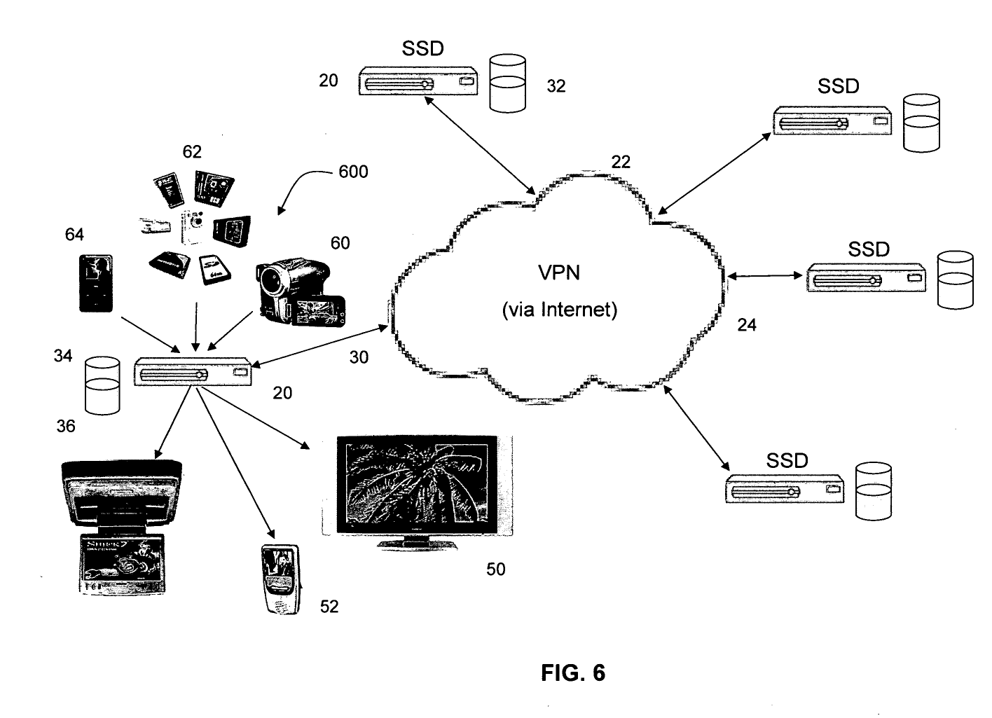

Referring now to FIG. 6, one embodiment of the present invention that facilitates access and exchange of primarily consumer-generated digital media content files is depicted. Unlike previously described embodiments, the VPN 22 of this embodiment does not necessarily include a VPN/VPSN server 26, nor does the embodiment necessarily include or rely upon management and authorization databases 27 or EPG databases 29. In this embodiment, VPN 22 includes one or more SSDs 20 linked via Internet 24. Each SSD 20 includes mass storage 32 that selectively stores digital media content files 28, such as a hard disk drive (HDD) that is preferably partitioned into a local mass storage 34 and a VPN mass storage 36. Other digital media devices capable of uploading or downloading digital media files may also be connected directly to VPN 22.

SSD 20 may be part of a household network 600, serving as a hub for a multitude of local digital media devices such as digital movie cameras 60, digital still cameras 62, and portable video or music devices 64. SSD 20 provides management and authorization services to the digital media devices in the household network, serving as a gateway to VPN 22.

An SSD 20 of household network 600 may receive digital media content files from commercial sources such as cable television 40, satellite television 42 and over-the-air television 44 as in previous embodiments. However, in this embodiment, each SSD 20 preferably receives primarily non-commercial digital media content files generated, for example, by a consumer or user of a digital media device. Consumer-generated digital media files 28 may include home video files, personally composed music files, digital photographs, consumer-written software programs, or data files for which the consumer will be the copyright owner or for which the consumer has another authorized, non-commercial relationship with the consumer, such as family and friends.

The consumer-generated digital media content files 28 may be received and sent by household SSD 20 via an Internet 24 connection to other SSDs 20 using known P2P file-sharing techniques. In one embodiment, entire files are stored in an SSD 20 and exchanged with other SSDs 20 via P2P file-sharing techniques.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

What is claimed is:

1. A system for delivery of digital media content over the Internet comprising:
a multitude of secured set-top devices (SSDs), wherein each SSD includes:
a main processor executing an operating system program and having a broadband connection to the Internet operably accessible to the main processor and at least one input connection to a content source other than the Internet;
means for storing digital media content, the means for storing including:
a first portion owned by the consumer and available for storing digital copies of media content for personal use by the consumer; and
a second portion licensed by the consumer and available for storing at least portions of digital copies of media content that the SSD will make available to other SSDs over the Internet;
program means executed by the SSD for cooperatively establishing a virtual private network (VPN) over the Internet with the other SSDs to selectively transfer at least portions of digital copies of media content stored on the second portion of the means for storing digital media content utilizing a peer-to-peer protocol; and
user interface means executed by the SSD for permitting the consumer to selectively control operation of the SSD, the user interface means including a navigation and program guide user interface that limits access by the consumer to the operating system program.

2. The system of claim 1 wherein the VPN is a virtual swarming private network (VPSN) and the peer-to-peer protocol is a packet-based, swarming peer-to-peer protocol.

3. The system of claim 1 wherein at least one SSD is purchased by a consumer.

4. The system of claim 1 wherein at least one SSD is owned by a digital media content provider.

5. The system of claim 1 wherein the navigation and program guide user interface includes data from an electronic program guide.

6. The system of claim 1, further comprising:
at least one server operably connected to the VPN over the Internet, the at least one server storing copies of digital media content authorized by an owner of the digital media content that are available for selective delivery to al least one of the SSDs on the VPN over the Internet.

7. The system of claim 6, wherein the at least one server is an SSD.

8. The system of claim 1 wherein the at least one SSD is linked into a credit card account provided by the consumer for authorized purchase of a copy of the digital media content.

9. The system of claim 2, further comprising means for enhancing the security of the VPN through the use of a keystoning technique.

10. The system of claim 1, wherein at least one SSD serves as a hub in a household network for a plurality of digital media devices.

11. The system of claim 1, wherein the digital media content includes consumer-generated digital media content.

12. A system for delivery of digital media content over the Internet comprising:
a multitude of secured set-top devices (SSDs), wherein each SSD includes:
a main processor executing an operating system program and having a broadband connection to the Internet operably accessible to the processor and at least one input connection to a content source other than the Internet;
means for storing digital media content, the means for storing including:
a first portion owned by the consumer and available for storing digital copies of media content for personal use by the consumer; and
a second portion licensed by the consumer and available for storing at least portions of digital copies of media content that the SSD will make available to other SSDs over the Internet;
program means executed by the SSD for cooperatively establishing a virtual private network (VPN) over the Internet with the other SSDs to selectively transfer digital complete copies of media content stored on the second portion of the means for storing digital media content utilizing a peer-to-peer protocol;
a multitude of digital media devices connected to at least one of the multitude of SSD, where the at least one SSD acts as a gateway device for a household network formed of the multitude of digital media devices by managing and authorizing access to the VPN; and
user interface means executed by the processor for permitting the consumer to selectively control operation of the SSD, the user interface means limiting access by the consumer to the operating system program.

13. The system of claim 12 wherein at least one SSD is purchased by a consumer.

14. The system of claim 12 wherein at least one SSD is owned by a digital media content provider.

15. The system of claim 12 wherein the user interface includes data from an electronic program guide.

16. The system of claim 12, wherein at least one of the multitude of SSDs is operably connected to the VPN over the Internet and stores copies of digital media content authorized by an owner of the digital media content that are available for selective delivery to at least one of the other SSDs on the VPN over the Internet.

17. The system of claim 12 wherein at least one of the multitude of SSDs is linked into a credit card account provided by the consumer for authorized purchase of a copy of the digital media content.

18. The system of claim 12, wherein the digital media content includes consumer-generated digital media content.

19. A secured set-top device (SSD) for delivery of digital media content over the Internet comprising:
a main processor executing an operating system program and having a broadband connection to the Internet operably accessible to the processor and at least one input connection to a content source other than the Internet;
means for storing digital media content, the means for storing including:
a first portion owned by the consumer and available for storing digital copies of media content for personal use by the consumer; and
a second portion licensed by the consumer and available for storing at least portions of digital copies of media content that the SSD will make available to other SSDs over the Internet;
program means executed by the SSD for cooperatively establishing a virtual private network (VPN) over the Internet with other SSDs to selectively transfer portions of digital complete copies of media content stored on the second portion of the means for storing digital media content utilizing a peer-to-peer protocol; and
user interface means executed by the processor for permitting the consumer to selectively control operation of the SSD, the user interface means limiting access by the consumer to the operating system program.

20. The system of claim 19 wherein the VPN is a virtual swarming private network (VPSN) and the peer-to-peer protocol is a packet-based, swarming peer-to-peer protocol.

21. A method for delivery of digital media content over the Internet comprising:
having at least one retailer sell secured set-top devices (SSDs) to consumers, each SSD having a unique identification, a broadband Internet connection, software for enabling a virtual private network (VPN) over the Internet and mass storage that is partitioned into a consumer portion and a VPN portion;
providing a VPN server system that controls access to third party digital media content files stored at least in part on the VPN portion of mass storage of a plurality of SSDs in which different SSDs are owned by different consumers;
having a consumer that purchases an SSD for one of the at least one retailers connect the SSD to the Internet and request at least one digital media content file to be delivered via the VPN to the SSD;
tracking the consumer request to the unique identification of the SSD of the consumer and correlating that unique identification with the retailer who sold the SSD; and
paying the retailer a portion of revenue generated by the consumer request for the digital media content file delivered via the VPN.
